(19) United States
(12) Patent Application Publication
(10) Pub. No.: US 2010/0200609 A1
(43) Pub. Date: Aug. 12, 2010

(54) Vehicle Fluid Dispensing Apparatus and Method of Use

(75) Inventor: Daniel J. Cadigan, Baton Rouge, LA (US)

Correspondence Address: CAROL WILSON;BP AMERICA INC., MAIL CODE 5 EAST, 4101 WINFIELD ROAD, WARRENVILLE, IL, 60555, US

(73) Assignee: Castrol Limited, Warrenville, IL (US)

(21) Appl. No.: 12/759,200

(22) Filed: Apr. 13, 2010

Related U.S. Application Data
(60) Provisional application No. 61/174,230, filed on Apr. 30, 2009.

(51) Int. Cl. B67D 7/08; B67D 7/62; B67D 7/78; B67D 7/06

(52) U.S. Cl. 222/1; 222/71; 222/132; 222/135; 222/144.5

(57) ABSTRACT

This invention relates to a vehicle fluid dispensing apparatus and a method of use. The apparatus includes a plurality of motive force devices for fluid communication with a plurality of reservoirs. The apparatus also includes a plurality of metering devices in fluid communication with the motive force devices and a single nozzle in fluid communication with the plurality of motive force devices.

This application claims the benefit of priority from U.S. Provisional Patent Application No. 61/174,230, filed Apr. 30, 2009, the entirety of which is expressly incorporated herein by reference.

### BACKGROUND

1. Technical Field

This invention relates to a vehicle fluid dispensing apparatus and a method of use.

2. Discussion of Related Art

Known vehicle fluid dispensing systems use a bulk storage tank and require an air permit for operation. Such known vehicle fluid dispensing systems are expensive to construct and are installed using rigid pipe and/or rigid tubing. There is a need and a desire for a vehicle fluid dispensing system that does not require an air permit for operation, costs less to construct, and can be installed without rigid pipe and/or rigid tubing.

Other known vehicle fluid dispensing systems have a separate hose and nozzle for each fluid dispensed. The technician selects a fluid and the corresponding hose. There is a need and a desire to dispense multiple vehicle fluids from the same nozzle.

### SUMMARY

This invention relates to a vehicle fluid dispensing apparatus and a method of use. This invention can include a vehicle fluid dispensing apparatus that does not require an air permit for operation, costs less to construct, and can be installed without rigid pipe and/or rigid tubing. The invention can also include the capability to dispense multiple vehicle fluids from the same nozzle, such as to save time for the technician.

According to a first embodiment, this invention includes an apparatus for dispensing a plurality of fluids from a plurality of reservoirs for use in vehicles. The apparatus optionally includes a plurality of reservoirs. The apparatus also includes a plurality of motive force devices in fluid communication with the plurality of reservoirs. The apparatus also includes a plurality of metering devices in fluid communication with the motive force devices and a single nozzle in fluid communication with the plurality of motive force devices.

According to a second embodiment, this invention includes an apparatus for dispensing a plurality of fluids for use in vehicles. The apparatus includes about three reservoirs to about ten reservoirs with each reservoir having a volume of about 22 liters, and includes a collapsible bladder and a support structure. The apparatus also includes a portable rack housing the reservoirs and pumps with each pump corresponding to one of the reservoirs. The apparatus also includes meters with each meter corresponding to one of the reservoirs. The apparatus also includes tubing connecting each reservoir to each pump, a hose including conduits from each pump, and a multi-product nozzle connected to the hose for dispensing any of the plurality of fluids without significant cross contamination.

According to a third embodiment, this invention includes a method of dispensing vehicle fluids. The method includes the step of selecting a fluid for dispensing from a plurality of fluids, and the step of optionally selecting a volume of the fluid for dispensing. The method also includes the step of placing a nozzle into a fluid receptacle, and the step of dispensing the fluid from a reservoir through a metering device and through a nozzle. The method also includes where each of the plurality of fluids flow through the same nozzle.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 illustrates a view of an apparatus for dispensing vehicle fluids, according to one embodiment;

FIG. 2 illustrates a schematic view of an apparatus, according to one embodiment;

FIG. 3 illustrates a top view of a nozzle, according to one embodiment;

FIG. 4 illustrates a side view of a nozzle, according to one embodiment;

FIG. 5 illustrates a cross sectional view of a hose, according to one embodiment;

FIG. 6 illustrates a schematic view of a motive force device, according to one embodiment; and

FIG. 7 illustrates a partial exploded view of a reservoir, according to one embodiment.

### DETAILED DESCRIPTION

This invention may include a vehicle fluid dispensing apparatus and a method of use. The vehicle dispensing apparatus of this invention can be used in any suitable application, such as quick oil change facilities (stand alone and/or part of a department store), service stations, fleet management locations, automotive dealer garages, transportation terminals, industrial equipment maintenance shops, and/or the like.

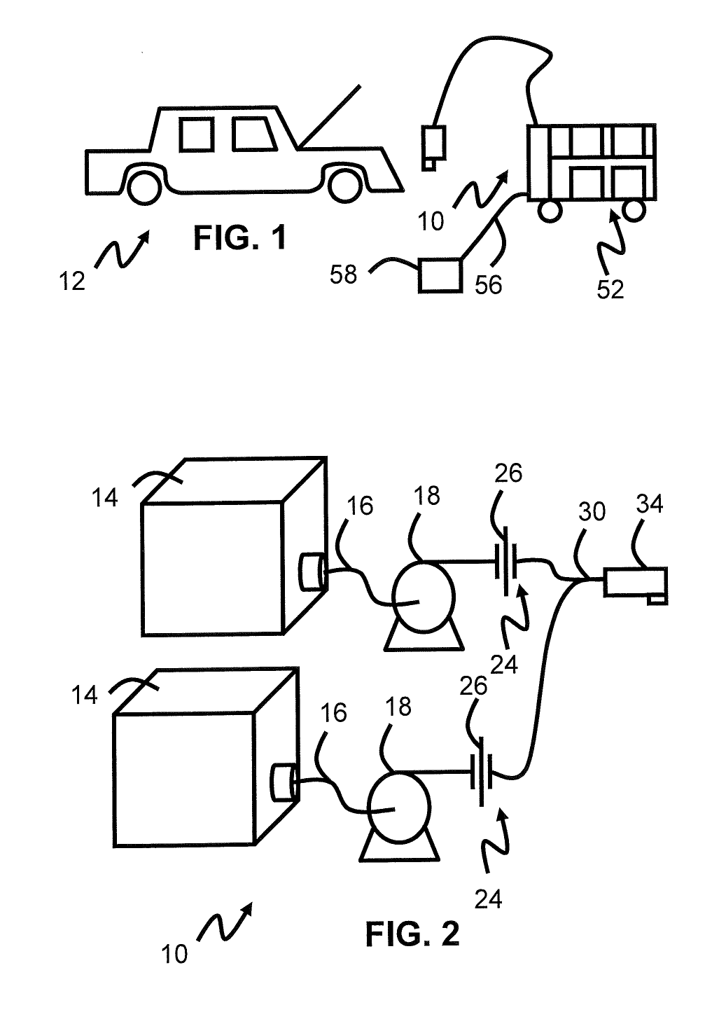

FIG. 1 illustrates a view of an apparatus 10 for dispensing vehicle fluids, according to one embodiment. The apparatus 10 can be used to dispense any suitable fluid into a vehicle 12, such as four different grades of lubricating oil. The apparatus 10 includes a rack 52, and a remote communication 56 to a computer system 58.

FIG. 2 illustrates a schematic view of an apparatus 10, according to one embodiment. The apparatus 10 includes multiple reservoirs 14 with tubing 16 connecting each reservoir 14 to a motive force device 18. The apparatus 10 also includes a metering device 24, such as a meter 26. The apparatus 10 also includes a hose 30 connecting the motive force devices 18 and/or the metering devices 24 to a single nozzle 34. The single nozzle 34 dispenses multiple fluids, such as with little or no cross contamination.

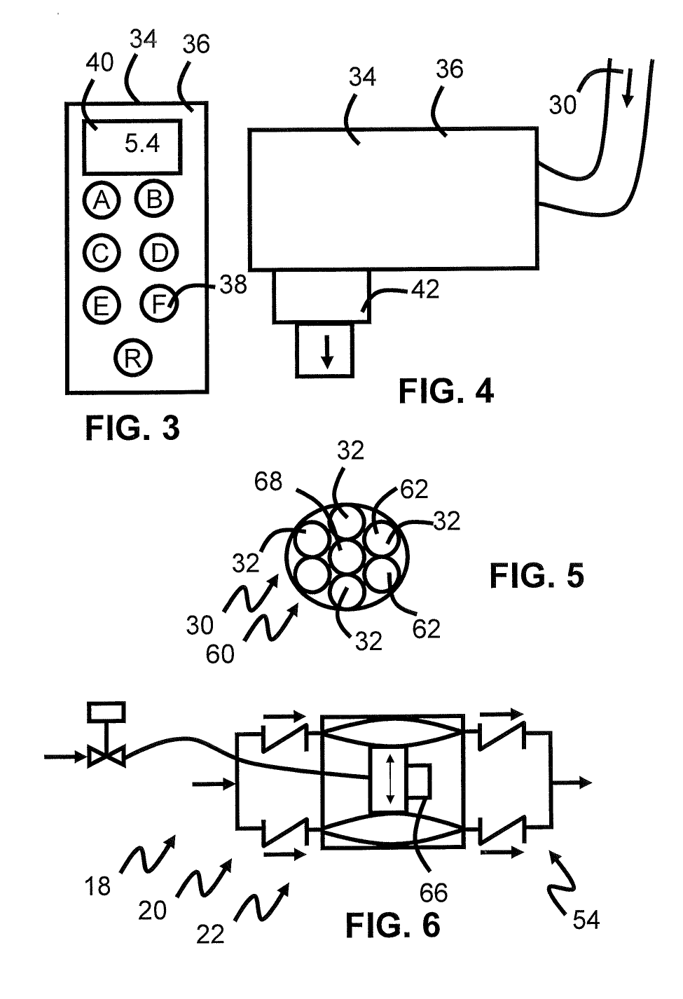

FIG. 3 illustrates a top view of a single nozzle 34, according to one embodiment. The single nozzle 34 can be a multi-product nozzle 36, such as for dispensing several different fluids. The single nozzle 34 includes buttons 38 and a display 40, such as for use by a technician in dispensing 6 different fluids.

FIG. 4 illustrates a side view of the single nozzle 34 shown in FIG. 3, according to one embodiment. The single nozzle 34 can be a multi-product nozzle 36, such as connected to a hose 30. The single nozzle 34 includes a spout 42 for dispensing the fluids into the vehicle.

FIG. 5 illustrates a cross sectional view of a hose 30, according to one embodiment. The hose 30 includes multiple conduits 32, such as tubing. The hose 30 can be a unitized hose 60, such as with a single external covering. The unitized hose 60 can include tubings 62, such as one tubing 62 for each different fluid dispensed. The unitized hose 60 may also include one or more conductors 68, such as for sending a signal from a single nozzle 34 (not shown) to a motive force device 18 (not shown).

FIG. 6 illustrates a schematic view of a motive force device 18, according to one embodiment. The motive force device 18 can be a pump 20, such as an air-driven diaphragm pump 22 with a solenoid to receive a signal from a conductor 68 (not shown) and/or control flow of air to the pump 20. The motive force device 18 and the metering device 24 (not shown separately) can be a single device 54, such as a positive displacement pump with a stroke counter 66.

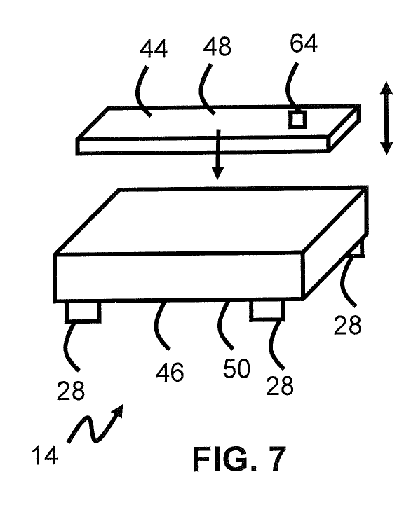

FIG. 7 illustrates a partial exploded view of a reservoir 14, according to one embodiment. The reservoir 14 includes a variable-volume vessel 44, such as a collapsible bladder 48. The reservoir 14 also includes an outer-fixed volume 46, such as a support structure 50. The outer-fixed volume 46 may hold and/or contain more than one variable-volume vessels 44, according to one embodiment. The reservoir 14 also includes a connection 64. The reservoir 14 may be placed on load cells 28, such as to form a metering device 24 (not shown).

According to one embodiment, this invention may include an apparatus for dispensing a plurality of fluids from a plurality of reservoirs for use in vehicles, equipment and/or the like. The apparatus may optionally include a plurality of reservoirs. The apparatus may also include a plurality of motive force devices in fluid communication with the plurality of reservoirs. The apparatus may also include a plurality of metering devices in fluid communication with the motive force devices, and a single nozzle in fluid communication with the plurality of motive force devices.

Dispensing broadly refers to dealing out in portions, to prepare and distribute, and/or the like.

Fluids broadly refers to having particles that easily move and change their relative position without a separation of the mass and/or that easily yield to pressure or are capable of flowing. Fluids can be compressible and/or noncompressible. Fluids generally have a volume but take on the shape of their container. Fluids can be liquids, gases, solutions, suspensions, slurries, emulsions, fine powders, and/or the like. Desirably, but not necessarily fluids have a single phase and can be at least somewhat homogeneous.

Any suitable fluid may be used in a vehicle, such as lubricating oils, synthetic lubricating oils, synthetic blend lubricating oils, mineral oil based lubricating oils, oil additive packages, gear oils, turbine oils, transmission fluids, brake fluids, power steering fluids, hydraulic fluids, differential fluids, clutch fluids, windshield washer fluids, coolants, battery acid, water, air, nitrogen, argon, helium, grease, refrigerant, gasoline, diesel, hydrogen, fuel additive packages, fuel injector cleaners, 2-cycle oil, steam, vacuum, and/or the like.

Lubricating oils may also be referred to as motor oils or engine oils, such as for use in a crank case, an oil pan, an oil sump, an oil filter, and/or the like of an internal combustion engine. Lubricating oils may include any suitable viscosity index and/or range. Single-grade oils may include SAE (Society of Automotive Engineers) 0, 5, 10, 15, 20, 25, 30, 40, 50, 60, 90, 120, and/or the like. Multi-grade oils may include 0W-30, 0W-40, 5W-20, 5W-30, 5W-40, 10W-30, 10W-40, 15W-40, 15W-50, 20W-40, 20W-50, 75W-90, and/or the like.

According to one embodiment, the lubricating oils may include multiple different grades or viscosities, such as a different product in each reservoir. In the alternative, some reservoirs may contain the same product, such as the most commonly dispensed grade and brand of lubricating oil. Supplying reservoirs in parallel to a common motive force device and/or a common metering device is within the scope of this invention, such as for increasing capacity.

Vehicles broadly refer to any suitable device used in transportation of goods and/or people, such as automobiles, cars, trucks, vans, all terrain vehicles, boats, aircraft, snowmobiles, locomotives, tractors, and/or the like. Vehicles may have any suitable engine or driving force, such as spark ignition internal combustion engines, compression internal combustion engines, homogeneous charge compression ignition (HCCI) engines, batteries, fuel cells, motors, turbines, and/or the like.

Equipment broadly refers to any suitable device used in commercial settings, industrial settings, residential settings, and/or the like. Equipment may include engines, turbines, gear boxes, compressors, extruders, presses, lathes, and/or the like.

Plurality broadly refers to more than one of an object or an item. A plurality of items may include 2, 3, 4, 5, 6, 7, 8, 9, 10, 12, 20, 50, and/or the like, for example.

Reservoir broadly refers to any suitable device or place where something is kept in store, such as a part of an apparatus in which a liquid is held. The reservoir may include any suitable size, shape, and/or volume. According to one embodiment, the reservoirs have a volume of between about 0.1 liters and about 10,000 liters, between about 1 liter and about 100 liters, between about 5 liters and about 50 liters, about 22 liters, and/or the like.

Reservoirs may include bottles, bags-in-boxes, pails (about 19 liters or about 5 gallons, for example), buckets, drums (about 208 liters or about 55 gallons, for example), totes, tanks, and/or the like. According to one embodiment, the reservoirs do not have an atmospheric vent. According to one embodiment, the reservoirs do not need an air permit from a regulatory agency for operation. Desirably, but not necessarily, the reservoirs can be moved and/or transported by a single person without assistance of additional equipment (dolly, fork truck, and/or the like), such as with a weight of less than about 20 kilograms and/or the like.

According to one embodiment, the reservoirs include a variable-volume vessel within an outer fixed-volume container, such as a bag-in-box. The variable-volume vessel may be any suitable device, such as a polymer bag. Suitable polymers may include polyethylene, polypropylene, polyester, laminated polymer structures, metal coated polymers, and/or the like. The variable-volume vessel may be a collapsible aluminum structure with pleats, accordion style diaphragms, and/or the like for collapsing. The outer fixed-volume container may be any suitable device, such as a cardboard box, a reusable shell (wood, metal, and/or plastic), and/or the like. Desirably, the combination of the variable-volume vessel and the outer fixed-volume container provide a relatively low cost, highly recyclable system, and/or reusable system. Highly recyclable systems generally leave little residual product in the reservoir and do not use special equipment for recycling, such as drum crushers and/or the like.

Desirably, the reservoir can include a fitting with a spring loaded valve, such as to prevent leakage and/or product loss when not connected to the apparatus. Optionally and/or alternatively, the reservoir may include an excess flow valve, such as to minimize product wastage, spill, loss, and/or the like, if a line rupture would occur.

Motive force devices broadly refer to any suitable device or item to move a fluid from one location to another, such as pumps, centrifugal pumps, positive displacement pumps, diaphragm pumps, tubing pumps, peristaltic pumps, rotary pumps, gear pumps, piston pumps, compressors, ejectors, eductors, and/or the like. Generally, the motive force devices increase a pressure to cause fluid to flow. Motive force devices may include any suitable drivers and/or movers, such as electric motors, hydraulic drives, pneumatic drives, turbines, and/or the like. According to one embodiment, the motive force devices may include air or gas driven diaphragm pumps. The motive force device may include any suitable flow rate, such as between about 0.1 liters per minute to about 50 liters per minute, between about 1 liter per minute to about 10 liters per minute, and/or the like.

According to one embodiment, gravity may provide the motive force device needed to move the fluid, such as mounting the reservoir above the height of the fluid needed for use or dispensing.

Fluid communication broadly refers to the ability for a fluid to flow and/or connect from one place or location to another. Fluid communication can by accomplished or provided by any suitable device, such as pipes, channels, conduits, tubes, hoses, valves, flow paths, and/or the like. According to one embodiment, the fluid communication between the reservoir, the motive force device, and/or the metering device can include polyvinyl chloride (PVC) tubing. Tubing can be rigid and/or flexible. According to one embodiment, the fluid communication between the motive force device and/or the metering device to the single nozzle can include polyvinyl chloride (PVC) tubing for each fluid. At least a portion of the tubings to the single nozzle can be unitized with an outer covering and/or shell, such as to form a hose with multiple conduits and/or flow paths.

The apparatus may include any suitable hose reels, davits, and/or tool balancers, such as to assist a technician in performing a task.

According to one embodiment, a flow path of the fluid does not include an actuated valve and/or a manual valve (on-off). In the alternative, the flow path may include an actuated valve and/or a manual valve.

Metering devices broadly refer to any suitable device or item to measure or count a regulated amount of a substance, such as a volume of vehicle fluid. Metering devices may measure mass, volume, and/or the like. The metering devices may include differential pressure flowmeters, velocity flowmeters, positive displacement flowmeters, mass flowmeters, and/or the like. The metering device may be on the suction or discharge of the motive force device, for example. According to one embodiment, the metering device may be a part of the motive force device, such as counting a number of strokes for a positive displacement pump. Desirably, the positive displacement pump moves a set volume of fluid for each stroke. The plurality of motive force devices and the plurality of metering devices may include a single device for each fluid.

Single nozzle broadly refers to one spout or opening for the exit of the plurality of fluids. The single nozzle dispenses or flows the plurality of fluids to a single point of use, such as for a technician performing an oil change and/or a check of fluid levels in a vehicle. Desirably, at least a portion of the single nozzle can fit within openings of the vehicle, such as a crank case opening, a radiator opening, a power steering opening, a windshield washer fluid opening, a brake fluid opening, a transmission opening, and/or the like.

The single nozzle may include any suitable size and/or shape. The single nozzle may include any suitable tubing, hose, valves, check valves, flow stoppers, and/or the like. The single nozzle may include a spout for directing fluid flow, such as a rigid spout, a bendable spout, a flexible spout, and/or the like. The spout can be removable, detachable, reusable, disposable, and/or the like. The spout can be any suitable length depending upon the use and/or application, such as between about 2 centimeters and about 100 centimeters, between about 10 centimeters and about 25 centimeters, and/or the like. Desirably, the single nozzle minimizes and/or prevents drips and/or leakage, such as by a check valve at a suitable location.

The single nozzle may be in fluid communication with the plurality of motive force devices in any suitable manner, such as tubing from each pump to the single nozzle. According to one embodiment, the apparatus may include a unitized hose having a plurality of tubings each corresponding to a reservoir, such as connecting to the single nozzle. The unitized hose may also include a suitable set of conductors, such as wires corresponding to each fluid for energizing a solenoid in the motive force device, and/or the like. Conductors broadly refer to any suitable device or item capable of sending or transmitting a signal and/or power, such as copper wires, fiber optics, and/or the like.

The single nozzle may include a button, a switch, a trigger, and/or the like corresponding to each fluid. The single nozzle may also include a display, such as a volume of the fluid dispensed and/or the type of fluid dispensed. The single nozzle may also include a reset switch, such as to zero and/or reset a totalizer and/or a counter on the volume dispersed or dispensed. In the alternative, the single nozzle may also include a touch screen interface.

According to one embodiment, the single nozzle dispenses the plurality of fluids without cross contamination. Cross contamination refers to an amount of material that is incompatible with the other fluid for its purpose.

The volume of cross contamination that may be acceptable can depend on the types of fluids and the applications. The cross contamination may be less than about 0.1 liters, less than about 0.05 liters, less than about 0.01 liters, less than about 0.001 liters, less than about 0.0001 liters, and/or the like. Cross contamination can occur by using the same tubing or conduit for different fluids.

According to one embodiment, the apparatus may include a rack for housing the plurality of reservoirs. Rack broadly refers to a framework for holding at least a portion of the reservoirs. The rack may be of any suitable size, material, and/or shape. Desirably, but not necessarily, the rack may be portable and/or movable, such as on wheels, casters, rollers, and/or the like. The rack may have two or more tiers and/or layers of reservoirs. Desirably, the bag-in-box fits within the rack. The rack may be self contained, such as movable by a technician between service bays within a shop environment and/or the like. The rack may include or house the motive force devices, a logic controller, an interface or touch screen, a printer, a battery, and/or the like.

According to one embodiment, at least a portion of the apparatus may be solar powered, such as by photovoltaic modules exposed to direct sunlight. The apparatus may include one or more batteries for storing electricity. The apparatus may include connections to suitable utilities, such as pressurized air, water, steam, electricity, and/or the like. In the alternative, the apparatus may be completely self contained and/or free standing, such as with on board generators, fuels, compressors, batteries, and/or the like.

The metering device may provide quantity dispensed and inventory control of the fluid with a remote communication. Displaying quantity dispensed of fluid may allow for a technician to accurately fill a volume of fluid in a vehicle. The inventory control can allow a shop owner to manage product consumption, reduce waste, reduce theft, and/or the like. The remote communication from the apparatus can provide information related for a job to another computer and/or system, such as a store database with electronic date interchange (EDI) and automatic reorder points. The remote communication may be by any suitable link, such as by a serial port, a parallel port, a universal serial bus, a network cable, a wireless communication, a fiber optic cable, a coaxial cable, the Internet, and/or the like.

When a car arrives at a service bay, a technician may scan a bar code, read an alphanumeric sequence, read a loyalty card, read a radio frequency identification (RFID) tag, and/or the like with the apparatus. The technician may receive information about the vehicle which may include the types of fluids needed, volumes of fluids needed, types of filters needed (oil, air, passenger cabin, and/or the like), types of accessories needed (headlamps, windshield wipers, and/or the like), service intervals, service histories, and/or the like. The technician may perform any needed services and check or fill the fluid levels with the apparatus.

The fluids may be dispensed by the technician holding down an appropriate button or switch while the fluid dispenses and the meter measures the amount. The technician can release the button, switch, and/or the like to stop the fluid flow when the needed amount is reached, such as when the technician reads the appropriate volume on a display. In the alternative, the apparatus may be set for a specific volume either by the technician or based on the information retrieved for the vehicle. The apparatus can then dispense the appropriate amount of fluid, such as when the technician initiates flow by pressing a button, a switch, and/or the like.

In the alternative, the apparatus may include a fast fill mode and a slower top off mode, such as a technician firmly holding down a button for fast fill mode and the technician tapping the button to jog the system to reach the appropriate volume with top off mode. The ratio of the fast fill mode rate of dispensing and/or flow rate to the top off mode rate of dispensing and/or flow rate can be any suitable value or ratio, such as at least about 2:1, at least about 5:1, and/or the like.

Any portion of the apparatus may be heat traced, such as to promote flow of viscous fluids. Heat tracing may include electrical resistance heaters, electrical inductance heaters, steam tubing, and/or the like. Some viscosity modifiers may be particularly difficult to cause to flow at ambient temperatures.

The apparatus may also provide for custom blending of fluids, such as mixing different grades of motor oil for a single crank case based on any suitable criteria. For example, a new car may use all 5W-30 oil. A medium aged car may use 75 percent 5W-30 oil and 25 percent 10W-40 oil. An older car may use 75 percent 10W-40 oil and 25 percent 20W-50 oil. Other combinations of blends are within the scope of this invention. In the alternative, an oil change may also include an additive package added to the crank case, such as viscosity modifiers, detergents, and/or the like.

The apparatus may also include provisions for extraction and/or removal of fluids from the vehicle, such as used motor oil by a vacuum hose through the crank case opening. Removing fluids by vacuum can reduce a risk of cross threading drain plugs, disturbing gaskets, and/or the like.

Optionally and/or additionally, the apparatus may include a point of sale interface, such as for a consumer to purchase a volume of a fluid. The point of sale interface may include the ability to conduct credit card transactions, debit card transactions, check transactions, cash transactions, and/or the like. The apparatus may dispense fluid directly into a vehicle by a customer, into a suitable container, any other suitable intermediate holding device, and/or the like.

According to one embodiment, this invention may include an apparatus for dispensing a plurality of fluids for use in vehicles, equipment and/or the like. The apparatus may include about three reservoirs to about ten reservoirs with each reservoir a having volume of about 22 liters (about 6 gallons). The reservoirs can include a collapsible bladder and a support structure, such as a bag-in-box. The apparatus may also include a portable rack housing the reservoirs, pumps with each pump corresponding to one of the reservoirs, and meters with each meter corresponding to one of the reservoirs. The apparatus may also include tubing connecting each reservoir to each pump, a hose with conduits from each pump, and a multi-product nozzle connected to the hose for dispensing any of the plurality of fluids without cross contamination.

According to one embodiment, the pump may include an air-driven diaphragm pump. In the alternative, the pump or motive force device may apply pressure directly to a portion of the collapsible bladder, such as to displace and/or squeeze the fluid from the reservoir. Actuated and/or automated valves in the flow path may provide control for flow of product or fluid. Gravity also may be used to assist fluid flow.

The meter may include load cells disposed with respect to each reservoir, according to one embodiment. One or more load cells may be placed under each reservoir, such as to measure mass and/or change in mass of the fluid. The apparatus may convert mass into volume based on density, for example. The load cells may include tare capabilities, such as a deduction from the gross weight of a substance and its container made in allowance for the weight of the container.

According to one embodiment, this invention may include a method of dispensing vehicle fluids, equipment fluids, and/or the like. The method may include the step of selecting a fluid for dispensing from a plurality of fluids, and optionally the step of selecting a volume of the fluid for dispensing. The method may also include the step of placing a nozzle into a fluid receptacle, and the step of dispensing the fluid from a reservoir through a metering device and through a nozzle. The method can include where each of the plurality of fluids flow through the same nozzle.

The fluid may include lubricating oil and the receptacle may include an engine crankcase, for example. The dispensed fluid may include a combination of one or more of the plurality of fluids. The dispensed fluid can be determined or selected based on vehicle age, mileage, type of vehicle, type of service, and/or the like.

The method may also include the step of selecting a different fluid for dispensing into the same receptacle or a different receptacle on a same vehicle or a different vehicle, according to one embodiment. For example, a technician may fill the crank case of a first vehicle with 10W-30 lubricating oil, top off the brake fluid of the first vehicle with Department of Transportation (DOT) 3 brake fluid, and then fill a crank case of a second vehicle with a synthetic 0W-30 lubricating oil.

According to one embodiment, the method may include the step of changing a reservoir when empty by disconnecting an old reservoir, connecting a new reservoir, and recycling at least a portion of the old reservoir. The technician may also scan a bar code on the reservoir or read an RFID tag on the reservoir when installing the new reservoir, such as to ensure proper fluid identification and/or usage, for example.

The method may also include the step of transmitting consumption data and/or inventory data from the apparatus to a computer system.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification be considered exemplary only, with a true scope and spirit of the invention being indicated by the following claims.

What is claimed is:

1. An apparatus for dispensing a plurality of fluids from a plurality of reservoirs for use in vehicles, the apparatus comprising:
a plurality of motive force devices for fluid communication with a plurality of reservoirs;
a plurality of metering devices in fluid communication with the motive force devices; and
a single nozzle in fluid communication with the plurality of motive force devices.

2. The apparatus of claim 1, wherein the single nozzle dispenses the plurality of fluids without cross contamination.

3. The apparatus of claim 1, wherein each reservoir comprises a variable-volume vessel within an outer fixed-volume container.

4. The apparatus of claim 1, further comprising a plurality of reservoirs wherein each reservoir has a volume of between about 5 liters and about 50 liters.

5. The apparatus of claim 1, further comprising a rack for housing a plurality of reservoirs.

6. The apparatus of claim 1, wherein the plurality of motive force devices and the plurality of metering devices comprise a single device for each fluid.

7. The apparatus of claim 1, wherein each metering device measures volume or mass.

8. The apparatus of claim 1, wherein each metering device provides quantity dispensed and inventory control with a remote communication.

9. The apparatus of claim 1, wherein the fluids comprise lubricating oils, synthetic lubricating oils, mineral oil based lubricating oils, synthetic blend lubricating oils, additive packages, transmission fluids, brake fluids, power steering fluids, hydraulic fluids, washer fluids, coolants, water, or air.

10. The apparatus of claim 9, wherein the lubricating oils comprise multiple different grades or viscosities.

11. The apparatus of claim 1, further comprising a unitized hose having a plurality of tubings each corresponding to a reservoir.

12. An apparatus for dispensing a plurality of fluids for use in vehicles, the apparatus comprising:
about three reservoirs to about ten reservoirs with each reservoir a having volume of about 22 liters and comprising a collapsible bladder and a support structure;
a portable rack housing the ten reservoirs;
pumps with each pump corresponding to one of the reservoirs;
meters with each meter corresponding to one of the reservoirs;
tubing connecting each reservoir to each pump;
a hose comprising conduits from each pump; and
a multi-product nozzle connected to the hose for dispensing any of the plurality of fluids without cross contamination.

13. The apparatus of claim 12, wherein each pump comprises an air-driven diaphragm pump.

14. The apparatus of claim 12, wherein each meter comprises load cells disposed with respect to each reservoir.

15. A method of dispensing vehicle fluids, the method comprising:
selecting a fluid for dispensing from a plurality of fluids;
optionally selecting a volume of the fluid for dispensing;
placing a nozzle into a fluid receptacle; and
dispensing the fluid from a reservoir through a metering device and through a nozzle, wherein the each of the plurality of fluids flow through the same nozzle.

16. The method of claim 15, further comprising selecting a different fluid for dispensing into the same receptacle or a different receptacle on a same vehicle or a different vehicle.

17. The method of claim 15, wherein the fluid comprises lubricating oil and the receptacle comprises an engine crankcase.

18. The method of claim 15, wherein the fluid comprises lubricating oils, synthetic lubricating oils, mineral oil based lubricating oils, synthetic blend lubricating oils, additive packages, transmission fluids, brake fluids, power steering fluids, hydraulic fluids, washer fluids, coolants, water, or air.

19. The method of claim 15, further comprising changing a reservoir when empty by disconnecting an old reservoir, connecting a new reservoir, and recycling the old reservoir.

20. The method of claim 15, further comprising transmitting consumption and inventory data from to a computer system.

21. The method of claim 15, wherein a dispensed fluid comprises a combination of one or more of the plurality of fluids.

22. The method of claim 21, wherein dispensed fluid is determined based on vehicle age, mileage, type of vehicle, or type of service.
